(19) United States
(12) Patent Application Publication
(10) Pub. No.: US 2004/0195095 A1
(43) Pub. Date: Oct. 7, 2004

(54) Increased solubilisation of hydrophobic proteins

(76) Inventors: Ben Herbert, New South Wales (AU); Jasmine Grinyer, Kurrajong (AU); Pier Giorgio Righetti, Milano (IT)

Correspondence Address: BOZICEVIC, FIELD & FRANCIS LLP, 200 MIDDLEFIELD RD, SUITE 200, MENLO PARK, CA, 94025, US

(21) Appl. No.: 10/474,586

(22) PCT Filed: May 24, 2002
(86) PCT No.: PCT/AU02/00666

(30) Foreign Application Priority Data
May 25, 2001 (AU) PR 5225

(51) Int. Cl. G01N 27/26

(52) U.S. Cl. 204/405; 530/412

(57) ABSTRACT

The present invention is directed to an immobilised pH gradient (IPG) gel for use in electrophoresis, the gel comprising polymerised units of (I) CH₂═CR₁—CO—NR₂R₃ and (II) CH₂═CR₄—CO—NR₅R₆ wherein R₁, R₂, R₃, R₄, R₅, and R₆, are the same or different and are hydrogen or C₁-C₄alkyl, with the proviso that at least one of R₁, R₂, R₃, R₄, R₅, or R₆ is C₁-C₄alkyl.

### FIELD OF THE INVENTION

The present invention relates to a method and apparatus for analysing macromolecules in a sample.

### BACKGROUND OF THE INVENTION

In the field of analysing macromolecules, one-dimensional and two-dimensional gel electrophoresis have become standard tools for separating and visualising macromolecules.

According to one-dimensional gel electrophoresis, mixtures of macromolecules such as proteins can be separated into individual components according to differences in mass by electrophoresing in a polyacrylamide gel under denaturing conditions. The mixture of macromolecules is first solubilised in a solution of, for example, 1% sodium dodecyl sulfate (SDS), which is an anionic, amphipathic detergent. With regard to proteins, this detergent disrupts nearly all non-covalent interactions in native proteins, ie most protein-protein and protein-lipid interactions. Anions of SDS bind to the main chain of a protein at a ratio of about one SDS for every two amino acid residues, which gives the complex of SDS and denatured protein a large net negative charge that is roughly proportional to the mass of the protein. The mixture of proteins is then electrophoresed in an acrylamide gel containing SDS.

A more sensitive means of separating, analysing and visualising mixtures of macromolecules is two-dimensional electrophoresis. Such two-dimensional electrophoresis usually involves sequential separations in a first dimension by isoelectric focusing and in a second dimension by SDS gel electrophoresis.

Isoelectric focusing separates proteins electrophoretically on the basis of their relative contents of acidic and basic residues. Under the influence of an applied electric field, a more highly charged protein will move faster than a less highly charged protein of similar size and shape. If the proteins are made to move from a sample zone through a non-convecting medium (typically a gel such as polyacrylamide), an electrophoretic separation will result. When the protein enters a region whose pH has that value at which the protein's net charge is zero (the isoelectric point, pI), it will cease to migrate relative to the medium. Further, if the migration occurs through a pH gradient that increases monotonically from the anode, the protein will “focus” at its' isoelectric point. Two proteins having different ratios of charged, or titrating, amino acids can be separated therefore by virtue of their different isoelectric points. In fact, this separation process can resolve two proteins differing by less than a single charged amino acid among hundreds in the respective sequences.

Isoelectric focusing is usually performed on thin flat strips of polyacrylamide gel containing a covalently immobilised pH gradient (eg. IPG gel strips). The IPG gel strips are commercially available in a dehydrated state and are rehydrated in an appropriate solution before use. Importantly, the rehydration solution must be compatible with the solution containing the proteins to be separated.

In practice, according to two dimensional gel electrophoresis, cell and tissue samples containing macromolecules of interest are lysed and solubilised with extraction solutions. The macromolecules of interest should be solubilised while still retaining their natural charge. Under non-denaturing conditions some membrane proteins can be solubilised by relatively mild means, such as extraction by a solution of non-ionic surfactants such as Triton X-100. Under denaturing conditions, many membrane proteins are relatively insoluble and can only be solubilised by strong surfactants and chaotropic agents, or organic solvents.

Solutions used to solubilise membrane proteins under denaturing conditions include solutions containing the chaotropic agent urea, which is a weak base and is weakly hydrophobic or thiourea. Solutions containing urea are therefore also used to rehydrate the IPG gels. For example urea solutions are known to be effective for solubilising weakly hydrophobic proteins and for use with commercially available gels (eg Pharmacia, Immobiline DryStrips). One particular conventional solution is 7M Urea, 2M Thiourea, 1% ASB-14, 2 mM TBP.

Cell membranes containing very hydrophobic proteins, however, appear to require very hydrophobic extracting solutions to solubilise the cell membrane proteins. Such high organic-based solutions have not previously been used in conjunction with two-dimensional electrophoresis because commercially available IPG strips (first dimension of two-dimensional electrophoresis) do not have the correct chemical composition to rehydrate in high organic-based solutions due to hydrophobic and hydrophilic interactions. For example, sulfolane extraction solutions are unable to rehydrate a conventional 100% acrylamide IPG strip. This has meant that weakly hydrophobic solutions have continued to be used in the solubilisation of proteins for isoelectric focusing.

### SUMMARY OF INVENTION

The present inventors have produced a hybrid IPG gel comprising a mixture of hydrophilic and hydrophobic monomers to produce improved IPG gels.

Preferably, the IPG gels of the present invention are more hydrophobic than commercially available gels and preferably, the IPG gels are amphiphilic and have improved stability. Further, these IPG gels can preferably be used with strong hydrophobic extracion solutions such as sulfolane, which provides the ability to extract a wider range of proteins and other macromolecules from a sample.

The invention provides a variety of gels with varying characteristics suitable for separation of a wide range of proteins and other macromolecules.

Accordingly, and in a first aspect, the present invention is directed to an immobilised pH gradient (IPG) gel for use in electrophoresis, comprising a mixture of hydrophilic and hydrophobic monomers wherein at least one of the monomers comprises one or more lower alkyl groups. Preferably, the gel comprises polymerised monomeric units of (I) CH₂═CR₁—CO—NR₂R₃ and (II) CH₂═CR₄—CO—NR₅R₆ wherein R₁, R₂, R₃, R₄, R₅ , and R₆, are the same or different and are hydrogen or C₁-C₄ alkyl, with the proviso that at least one of R₁, R₂, R₃, R₄, R₅, or R₆ is C₁-C₄ alkyl.

In a first preferred embodiment of the first aspect, the present invention is directed to an IPG gel for use in electrophoresis, wherein the gel comprises a mixture of acrylamide and Dimethylacrylamide (DMA) or N-Acryloyl amino propanol (MP) and Dimethylacrylamide (DMA).

In a second aspect, the present invention is directed to a method for separating and/or analysing at least one macromolecule in a sample comprising performing isoelectric focusing on a sample using an IPG gel of the invention as described herein.

Preferably, the method further comprises solubilising at least one macromolecule in the sample.

The method as described in the second aspect is preferably followed by further separation or analysis by SDS-polyacrylamide gel electrophoresis. In a particularly preferred embodiment, such separation is performed on a SDS-polyacrylamide gel.

The method of the second aspect is preferably combined with a conventional method of separation to achieve the improved separation and analysis.

In a third aspect, the present invention provides use of the IPG gel of the invention as described herein to separate and analyse at least one macromolecule in a sample. Preferably the macromolecule is a protein in a mixture of proteins.

In a fourth aspect, the present invention is directed to a kit for separating and/or analysing a macromolecule in a sample, the kit comprising: a solubilising agent, an immobilised pH gradient (IPG) gel of the invention and optionally instructions for use.

### DETAILED DESCRIPTION OF THE FIGURES

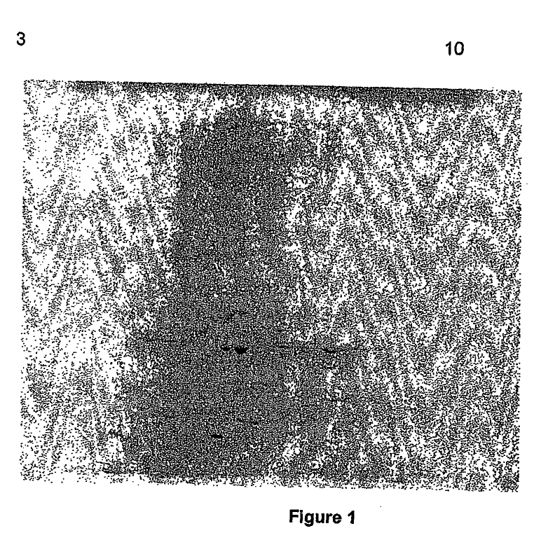

FIG. 1 is a copy of a photographic representation of AAP+DMA IPG strips, comprising whole cell protein extracts of E.coli extracted and separated in conventional solutions.

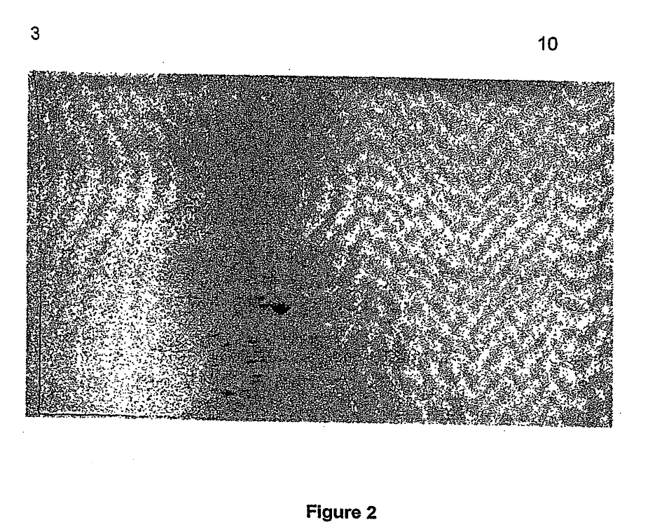

FIG. 2 is a copy of a photographic representation of AAP+DMA IPG strips comprising whole cell extracts of E.coli extracted and separated in sulfolane solutions.

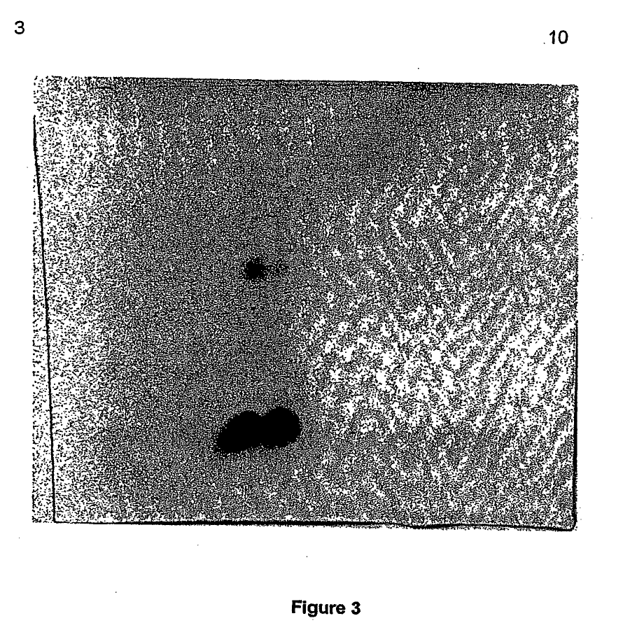

FIG. 3 is a copy of a photographic representation of AAP+DMA IPG strips, comprising Native human plasma extracted and separated in water based extraction solution.

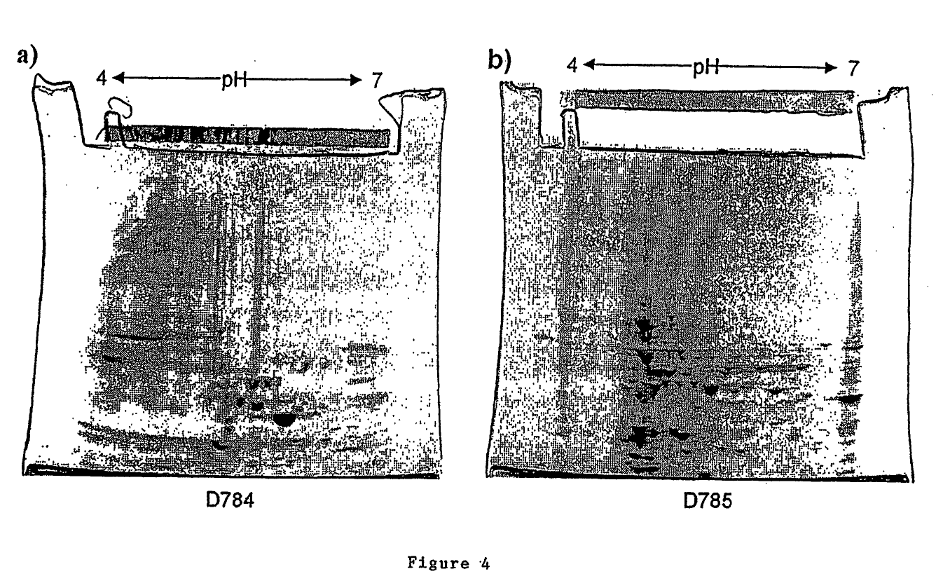

FIG. 4 is a copy of a photographic representation of E.coli whole cell preparation extracted and separated using conventional and sulfolane solutions. In FIG. 4(a) conventional solution was focussed on a 7 cm 4-7 Pharmacia IPG strip. In FIG. 4(b) Sulfolane extraction solution was focused on a laboratory made 7 cm 4-7 IPG containing acrylamide and DMA.

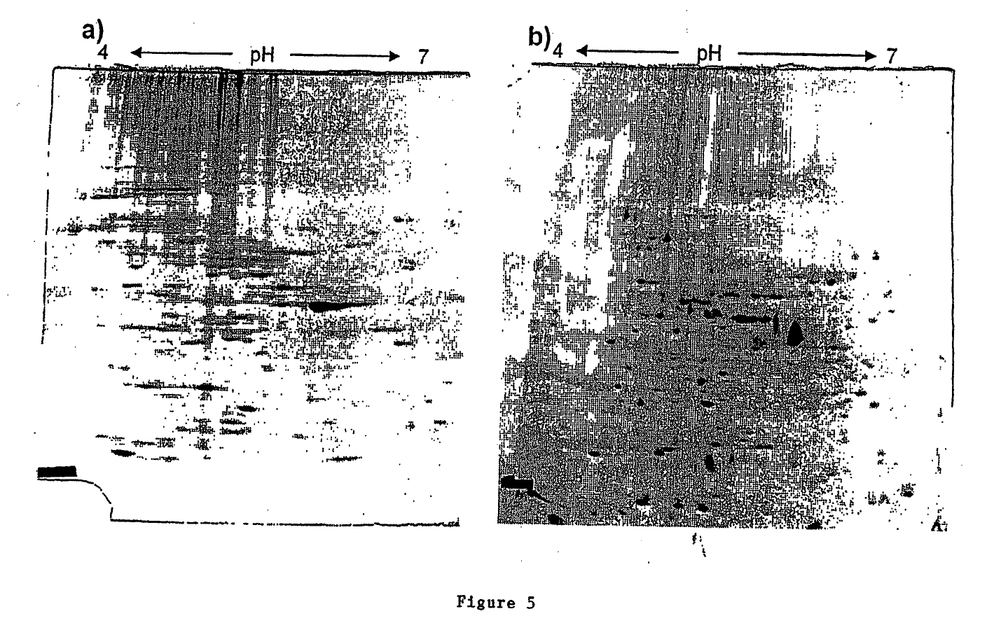

FIG. 5 is a copy of a photographic representation of E.coli whole cell preparation extracted and separated using conventional and sulfolane extraction solutions. In FIG. 5(a) conventional extraction solution was focussed on a 18 cm 4-7 Pharmacia IPG strip. In FIG. 5(b) Sulfolane solution was focussed on a laboratory made 18 cm 4-7 IPG containing acrylamide and DMA.

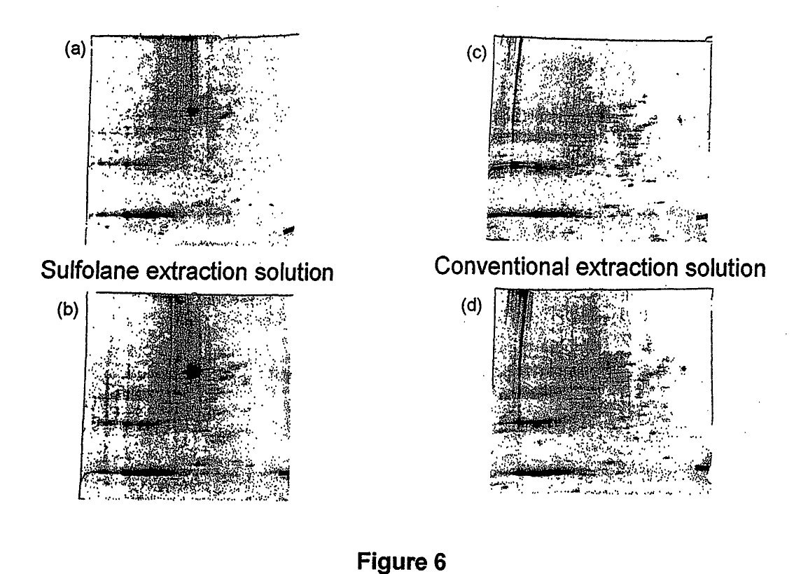

FIG. 6 is a copy of a photographic representation of rat liver whole cell preparation extracted and separated using conventional and sulfolane solutions.

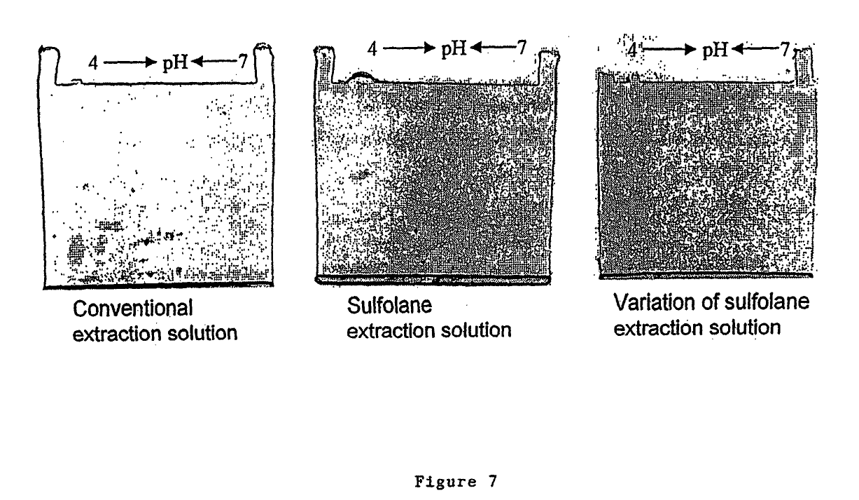

FIG. 7 is a copy of a photographic representation of E.coli membrane preparations extracted and separated using conventional and sulfolane solutions. In FIG. 7(a) conventional extraction solution was used to extract proteins. In FIG. 7(b) sulfolane extraction solution was used to extract proteins. In FIG. 7(c) a variation of sulfolane extraction solution (6M Sulfolane 4M Thiourea, 1% ASB-14, 2 mM TBP) was used to extract proteins.

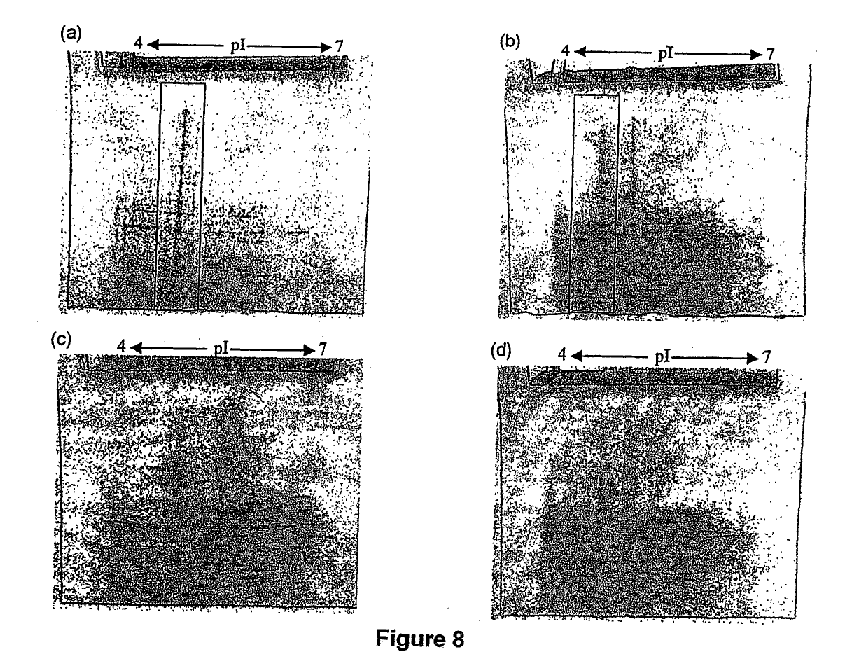

FIG. 8 is a copy of a photographic representations of reducing the ion front at the acidic end of the gel by cleaning sulfolane extraction solutions with activated charcoal and AG501×8 resin. The following solutions are used: (a) sulfolane solution comprising sulfolane, thiourea, C7 that have not been treated with resin, (b) sulfolane solution comprising sulfolane, thiourea and ASB14 that have not been treated with resin, (c) sulfolane solution comprising sulfolane, thiourea, C7 that have been treated with charcoal and Biorad AG501×8 Resin; (d) sulfolane solution comprising sulfolane thiourea ASB14 that has been treated with charcoal and Biorad AG501×8 Resin.

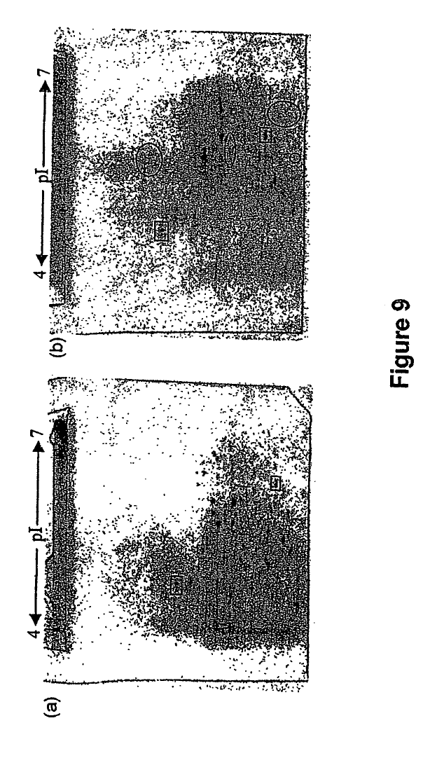

FIG. 9 is a copy of a photographic representations of comparing sulfolane solutions with conventional sample extraction solutions. The gels represent 1 mg/mL E. coli whole cell protein extraction in either (a) conventional (b) sulfolane extraction solutions. The boxed regions are proteins that are found in both gels, the circled areas represents some proteins that are not seen using conventional extraction solutions.

### ABBREVIATIONS

| | |
|---|---|
| AAP | N-Acroyl amino propanol |
| DMA | dimethyl acrylamide |
| SDS PAGE | Sodium dodecyl sulphate polyacrylamide |
| | gel electrophoresis |
| TEMED | N,N,N′,N′-tetramethylethylenediamine |
| APS | Ammonium persulphate |
| T | Total acrylamide |
| C | Cross-linker |
| ASB | Amidosulfobetaine; Tetradeconoylamido propyl |
| | dimethyl ammonio propane sulfonate |
| TBP | Tributyl phosphine |
| PDA | Piperazine diacrylamide |
| Tris | Tris buffer |
| MQ water | Milli-Q water (purified water) |

### DETAILED DESCRIPTION OF THE INVENTION

According to the present invention, the IPG gel comprises a mixture of hydrophilic and hydrophobic monomer subunits wherein at least one of the subunits comprises one or more lower alkyl groups. Preferably, the IPG gel of the present invention is more hydrophobic than those gels produced with acrylamide alone.

Polymerised Gel Matrix

According to the first aspect the gel is an immobilised pH gradient gel, preferably comprising polymerised units of (I) CH₂═CR₁—CO—NR₂R₃ and (II) CH₂═CR₄—CO—NR₅R₆.

Preferably R₂ and R₃ of unit (I) are C₁-C₄ alkyl, more preferably R₂ and R₃ are CH₃. In a particularly preferred embodiment, in unit (I) R₁ is H, R₂ and R₃ are CH₃.

In an alternate embodiment, in unit (II) R₅ and R₆ are the same or different and are hydrogen or propanol. In one embodiment, R₄, R₅ and R₆ are H. In a most preferred embodiment, in unit (II) R₄ and R₅ are H, R₆ is propanol.

In one embodiment, the molar ratio of unit (I): unit (II) is about 1:10 to 10:1. Preferably the molar ratio of unit (I): unit (II) is about 1:5 to 5:1, more preferably about 1:2 to 2:1 and most preferably 1:1.

In a preferred embodiment, the gel can be dried and stored in its desiccated state.

In one preferred embodiment, the gel comprises a mixture of DMA and acrylamide. DMA is a hydrophobic molecule differing from acrylamide by two extra methyl groups. Preferably this IPG gel will substantially rehydrate in conventional extraction sample solutions and hydrophobic sulfolane solutions.

Preferably, rehydration is measured by the uptake of solution into the IPG strip. Preferably this can be done by calculating the weight difference between a dry and a rehydrated gel. Preferably the strip rehydrates to at least the “cast volume”, ie length x width x thickness at the time of casting.

In another preferred embodiment, the gel comprises a mixture of AAP and DMA. Preferably this gel is capable of being rehydrated with sulfolane extraction solutions, conventional extraction solutions, and water based extraction solutions.

In a particularly preferred embodiment, the IPG gel has about a 1:1 molar ratio of acrylamide and DMA or MP and DMA.

Preferably, the IPG gel is stable and has amphiphilic properties.

According to the present invention, a stable gel plate is one that can be washed dried and stored for a convenient amount of time before being used. Preferably, a stable gel plate is able to be stored for up to about 1 year at room temperature or cool temperatures without loosing its functionality. Preferably, the gel plate is able to be rehydrated, provide an established pH surface property, and show relatively little tendency to become brittle or less pliable, following storage. Preferably the gel plate is substantially resistant to chemical breakdown of the polymerised hydrogel for time when stored in suitable conditions (dark room or cool temperatures).

Preferably, gel plates according to the present invention are tested for stability according to standard methods as described in

1) Kirkwood, T. B. L Predicting the stability of biological standards and products. Biometrics 33:736-742 (1977)

2) Porterfield, R. I, and Capone, J. J. Applications of Kinetic models and Arrhenius methods to product stability evaluations. Med. Devices Diagn. Industry April 1984, pg 45-50.

3) Kennon, L. Use of models in determining chemical pharmaceutical stability. J. Pharm. Sci. 53:815-818 (1964) which references are incorporated herein by way of reference.

Preferably, gel plates according to the invention are tested for chemical stability to acidic or alkaline conditions. Preferably, dimethyl acrylamide and MP have better hydrolytic stability than acrylamide. See for example, Electrophoresis 1996 April: 17 (4):723-31, incorporated herein by reference.

In one embodiment the IPG gel is an IPG gel strip or an IPG gel slab.

Preferably, a gel slab is a whole sheet of gel as polymerised. Preferably, a strip is typically a narrow (between 3 and 10 mm wide) piece of a slab cut out and used for 2-D gels. Preferably, a slab is anything wider than what would be typically used for 2-D gels. Typically, commercial IPGs are 3.3 mm wide.

Preferably an IPG gel strip is attached to a backing sheet.

Preferably, the backing sheet is a plastic backing sheet. Preferably the plastic is treated plastic. Preferably, the treatment causes the polymerising acrylamide to crosslink to the plastic and thus stabilise the gel.

In a second aspects the present invention is directed to a method for separating and/or analysing at least one macromolecule in a sample comprising performing isoelectric focusing on a sample using an IPG gel of the invention as described herein

In a preferred embodiment, the method comprises solubilising a macromolecule in the sample.

Preferably, the solubilisation is performed by a process comprising mixing the sample with a hydrophobic solvent.

Preferably, the solubilised macromolecule is a solubilised proteinaceous macromolecule (eg. a peptide, polypeptide, protein or protein complex).

In one embodiment, the method further comprises mixing an alkylating agent, preferably a cysteine alkylating agent, for example acrylamide or iodoacetamide with the solubilised sample.

Preferably, the sample is selected from the group consisting of an extra-cellular fluid, tissue sample, cell sample, microorganism sample and a culture sample. Preferred examples of samples include but are not limited to, E.coli samples and rat liver samples.

Preferably, the IPG gels according to the present invention are compatible with strongly hydrophobic extraction solutions such as solvents containing sulfolane and other hydrophobic solvents such as those solutions that are unable to rehydrate a conventional IPG gel or strip. When cell samples are lysed in a hydrophobic eg. sulfolane solution the hydrophobic proteins are typically solubilised. The present inventors have found that cell samples lysed in sulfolane solution successfully solubilised proteins that were then displayed on two-dimensional gels. The protein resolution displayed on the gels outperformed the strongest sample solubilisation solution currently commercially available.

Accordingly, preferably, the hydrophobic solvent comprises an active ingredient selected from the group consisting of: sulfolane, sulfolene, urea, thiourea, butylurea, dimethylurea, tributyl phosphate, dimethyl sulfoxide, dimethyl formamide.

In one embodiment, the hydrophobic solvent also comprise other ingredients such as a surfactant, for example, CHAPS, Triton X100, ASB 14, C7bZO, SB 3-10, or any non-ionic or zwitterionic surfactant or mixture thereof, or alternatively, or in addition, the solvent may comprise a reducing agent, for example, Dithiothreitol (DTT), dithioerythritol (DTE), TBP, tris cyanoethyl phosphine (TCEP), tris carboxyethyl phosphine (TCEP), or mercapto ethanol, or mixture thereof.

In one embodiment, the hydrophobic solvent comprises sulfolane, sulfolene or a mixture thereof.

Preferably the hydrophobic solvent is a sulfolane solution. In one embodiment the sulfolane solution is used to extract total protein from a tissue sample. Preferably, very hydrophobic proteins are extracted from a sample. In one embodiment very hydrophobic proteins include, for example, membrane proteins from E.coli.

In one embodiment, the hydrophobic solvent comprises about 0.1M to about 10.58M sulfolane, (saturating or 100% sulfolane). Preferably, the sulfolane solution comprises 1M to 8M sulfolane, more preferably 2M to 6M sulfolane, more preferably, 3M to 5M sulfolane and most preferably 4M sulfolane.

Preferably, the hydrophobic solvent further comprises thiourea, ASB14 and TBP. In one particular embodiment the hydrophobic solvent comprises 4M sulfolane, 4M thiourea, 1% ASB-14, 2 mM TBP.

In an alternate embodiment, the hydrophobic solvent comprises a commercially available solvent such as those containing urea, more particularly 7M urea. Preferably, the hydrophobic solvent also comprises thiourea, ASB14 and TBP. In one particular embodiment the urea solution comprises 7M urea, 2M thiourea, 1% ASB14, 2 mM TBP.

In a third aspect, the present invention is directed to use of the IPG gel of the invention as described herein to separate or analyse a macromolecule in a sample, such as for example, to separate or analyse a proteinaceous molecule (eg. a peptide, polypeptide, protein or protein complex) in a complex mixture of proteins.

In a fourth aspect, the present invention is directed to a kit for separating and/or analysing at least one macromolecule in a sample, the kit comprising a solubilising agent, an immobilised pH gradient (IPG) gel of the invention and optionally instructions for use.

Preferably, the solubilising agent is a hydrophobic solvent.

Preferably, the hydrophobic solvent comprises an active ingredient selected from the group consisting of sulfolane, sulfolene, urea, thiourea, butylurea, dimethylurea, tributyl phosphate, dimethyl sulfoxide, dimethyl formamide, a surfactant and a reducing agent.

In a preferred embodiment, the hydrophobic solvent comprises 4M sulfolane, 4M thiourea, 1% ASB-14, and 2 mM TBP.

Preferably, the kit further comprises an alkylating agent, preferably a cysteine alkylating agent such as acrylamide or iodacetamide.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

The present invention is further described by the following non-limiting examples.

### EXAMPLE 1

IPG Pouring of the Acrylamide and DMA IPG Strips

The acrylamide solution required for pouring these IPGs is composed of 50% acrylamide and 50% DMA (on a molar basis). The percentage of acrylamide used to pour IPGs is 40%T, 4%C. Therefore the acrylamide recipe is as follows:

40% T, 4% C:

| | | |
|---|---|---|
| Acrylamide | 19.5 | g |
| Dimethylacrylamide (DMA) | 27.26 | mL |
| PDA | 1.6 | g |

make to 100 mL
with MQ water

To pour a 7 cm, 4-7 DMA IPG (0.5 mm) the following recipe was determined using Dr pH:

| pH 4 | pH 7 |
|---|---|
| Immobiline 3.1, 150.5 uL | Immobiline 4.6, 56.6 uL |
| Immobiline 4.6, 174.9 uL | Immobiline 6.2, 191.6 uL |
| Immobiline 6.2, 174.6 uL | Immobiline 7.0, 53.5 uL |
| 40% T, 4% C, 625 uL | 40% T, 4% C, 625 uL |
| 3 mL 50% Glycerol | make to 5 mL with MQ |
| 64 uL 1 M Tris | |
| make to 5 mL with MQ | |

To pour a 7 cm, 3-10 DMA IPG (0.5 mm) the following recipe was determined using Dr pH

| pH 3 | | | pH 10 | | |
|---|---|---|---|---|---|
| Immobiline 3.1 | 41.4 | uL | Immobiline 4.6 | 12 | uL |
| Immobiline 4.6 | 238.4 | uL | Immobiline 6.2 | 276.8 | uL |
| 40% T | 4% | C, 625 uL | Immobiline 7.0 | 90.4 | uL |
| 3 mL | 50% | Glycerol | Immobiline 8.5 | 46.6 | uL |
| 1 M Tris | 58 | uL | Immobiline 9.3 | 74 | uL |

| MQ water | make to 5 mL | 40% T, 4% C | 625 | uL |
|---|---|---|---|---|
| | | 1 M Acetic acid | 40 | uL |
| | | MQ water | make to | |
| | | | 5 | mL |

To both the above solutions, 2 uL of TEMED and 5 uL of 40% APS were added, before the IPG gradient was poured using a mini gradient pourer. The IPGs were allowed to polymerise at 50 degrees for 1 hour. They are then washed in 10% methanol three times and once in 5% Glycerol, 10% methanol and allowed to dry overnight. The IPGs are then ready to cut into strips, stored at −20° C. or −80° C. until required to be used for rehydration.

### EXAMPLE 2

IPG Pouring of the AAP and DMA IPG Strips

The IPG strips had a pH gradient of 3-10 and a 7 cm slab gel was made. The recipes for the acrylamide solution and the 3-10 solutions are outlined. 40% T, 4% C acrylamide solution was made using a 50:50 Molar ration of DMA and AAP.

| Dimethylacrylamide | 0.546 | mL |
|---|---|---|
| N-acryloyl amino propanol | 1.42 | mL |
| Piperazine Diacrylamide | 0.032 | g |
| Water | final volume of | |
| | 2 | mL |

IPG pouring pH chambers.

| pH 3 | | | pH10 | | |
|---|---|---|---|---|---|
| Immobiline 3.1 | 41.4 | uL | Immobiline 4.6 | 12 | uL |
| Immobiline 4.6 | 238.4 | uL | Immobiline 6.2 | 276.8 | |
| 40% T, 4% C | 625 | uL | Immobiline 7.0 | 90.4 | uL |
| 50% Glycerol | 3 | mL | Immobiline 8.5 | 46.6 | uL |
| 1 M Tris | 58 | uL | Immobiline 9.3 | 74 | uL |
| MQ water | make to | | 40% T, 4% C | 625 | uL |
| | 5 | mL | 1 M Acetic Acid | 40 | uL |

| MQ water | make to | |
|---|---|---|
| | 5 | mL |

The procedure for IPG pouring was followed (as for the acrylamide and DMA IPG strip).

### EXAMPLE 3

Sulfolane Treatment, to Improve the Performance of the Sulfolane.

1. Heat the sulfolane to approx 50° and pass it through a column of activated charcoal. This can also be done in a batch process.

2. Deionising (with mixed bed ion exchange resin) the sulfolane/thiourea solutions prior to addition of the surfactant/s and reducing agent/s.

### EXAMPLE 4

E.coli Total Protein Extraction

Lyophilised E.coli was purchased from Sigma (EC1) and used throughout these experiments. The E.coli was resuspended in 5 mL of either conventional extraction solution or sulfolane extraction solution. They were then ultrasonicated for 1.5 minutes in 15 second blasts and kept on ice to keep cool. Each sample was spun for 10 minutes at 21000×g and the supernatants were removed and used to rehydrate either DMA IPGs (sulfolane extraction solution) or Pharmacia IPGs (conventional extraction solution).

### EXAMPLE 5

Rat Liver Total Protein Extraction

One frozen rat liver (7.65 g wet weight) was thawed and cut into small pieces before being ground in liquid nitrogen. The liver was divided into three and extracted into 20 mL of either conventional extraction solution, sulfolane extraction solution or a variation of the sulfolane extraction solution (6M Sulfolane, 4M Thiourea, 1% ASB-14, 2 mM TBP). The samples were sonicated using the probe at 70% intensity for 4×15 seconds, keeping cooI on ice. The samples were then spun at 14000 ×g for 45 minutes and the supernatant was collected and used for IPG rehydration.

### EXAMPLE 6

E.coli Membrane Protein Extraction

Two 1 mL aliquots of frozen E.coli was thawed and pooled. To the pooled sample, 10 mL of ice cold 100 mM sodium carbonate was added. The sample was then ultrasonicated (1×15 seconds at 30% intensity, 3×15 seconds at 40% intensity and 2×15 seconds at 50% intensity) and kept on ice to keep cool. The sample was spun for 10 minutes at 2500 rpm at room temperature. To the supernatant, 90 mL of 100 mM sodium carbonate was added and the sample was stirred on ice for 1 hour. The sample was then spun at 115000×g for 1 hour at 4 degrees to pellet membrane proteins. The pellet was then washed twice using 1.5 mL of 50 mM Tris-HCl, pH 7.3 and divided into 4 eppendorf tubes. After each wash the proteins were spun at 21000×g for 10 minutes at room temperature. The pellets were resuspended in 500 uL of either conventional extraction solution, sulfolane extraction solution or a variation of the sulfolane extraction solution (6M Sulfolane, 4M Thiourea, 1% ASB-14, 2 mm Tributyl phosphine). The samples were placed in the sonic bath for 5 minutes before being spun at 21000×g for 10 minutes at room temperature. The supernatant was collected and used for IPG rehydration.

### EXAMPLE 7

Preparation of Native Human Plasma

Human blood (50 mL) was collected and heparinised. The sample was spun at 2000×g for 20 minutes at 4 degrees. The plasma was carefully removed for the red blood cells and stored at −80 degrees.

### EXAMPLE 8

IPG Strip Rehydration

The E.coli samples were applied to the hybrid IPG strips without dilution of the sample. Rat liver samples were diluted five times with extraction solution (containing no protein) before being loaded onto IPG strips. Human plasma (native) was diluted with water more than 60 times before the sample was applied to an AAP+DMA IPG strip. For each sample 125 μL was applied to the IPG strip with a trace of Orange G being added as a tracking dye. IPG strips were typically allowed to rehydrate for 5-6 hours.

### EXAMPLE 9

IPG Focusing

Focusing of the IPG strips was conducted on the Pharmacia Consort unit (Model E752). The program for isoelectric focusing was 300 Volts for 4 hours, 1000 Volts for 4 hours, 2500 Volts for 4 hours and 5000 Volts for 4-5 hours. This gives a maximum KVh of 35-40.

### EXAMPLE 10

Equilibration of IPG Strips

The E.coli samples and rat liver samples in sulfolane extraction solution were equilibrated with Equilibration solution (6M Urea, 2% w/v SDS, 1× Tris-HCl gel buffer, pH 8.8, 20% Glycerol, 2.5% Acrylamide, 5 mM TBP) for 2×5 minutes, 1×10 minutes before the second dimension gels were run. The human plasma (native) sample was equilibrated for 20 minutes with 1× Tris-HCl gel buffer, pH 8.8, 20% Glycerol. All IPG strips rehydrated with conventional extraction solution were equilibrated in equilibration buffer (6M Urea, 2% w/v SDS, 1× Tris-HCl gel buffer, pH 8.8, 20% Glycerol, 2.5% Acrylamide, 5 mM TBP) for 1×20 minutes.

### EXAMPLE 11

Second Dimension Gels

The second dimension gels used for the E.coli and rat liver samples were Novex 4-12% 1.5 mm thick Bis-Tris gels. The IPG strips were embedded on these gels using 0.5% agarose in 1×MOPS buffer (50 mM MOPS, 50 mM Tris, 0.1% SDS, 1 mM EDTA) and a trace of bromophenol blue. The second dimension was run using a constant current consisting of 5 mA/gel for 30 mins, 10 mA/gel for 30 mins, 20 mA/gel for 1 hour and 25 mA/gel for 2 hours. The second dimension has finished when the bromophenol blue dye front has run from the gel. The human plasma samples were run on Novex 3-8% 1.5 mM Tris-Acetate gels. The IPG strips were embedded onto these gels with 0.5% agarose in 1× Tris-Acetate gel running buffer(50 mM Tricine, 50 mM Tris without SDS to keep the plasma in its native form) and a trace of bromophenol blue. The second dimension was run using a constant current of 2 mA/gel for 1 hour, 5 mA/gel for 1 hour, 10 mA/gel for 2 hours and 15 mA/gel for 2 hours. The dye front was run off the gel, with the gel run continuing for a further 30 minutes.

### EXAMPLE 12

Protein Detection

All of the samples used for this experiment were detected with Colloidal Coomassie G-250. After the gel run was complete, the gels were removed from their cassettes and stained in G-250. The stain was changed once before staining continued overnight The gels were then destained in 1% acetic acid for 24 hours before being scanned (Hewlett Packard Scanjet 5200 at 150 dpi) and imaged.

### EXAMPLE 13

Results from Acrylamide and DMA IPG Strips

The results indicate that sulfolane extraction solution is a superior extraction solution to the conventional extraction solutions as it extracts more proteins and shows a better resolution of extracted proteins especially at the alkaline end of the IPG. DMA IPGs prevent precipitation of proteins at the alkaline end of the IPG, indicating that alkaline hydrolysis has been significantly reduced, hence improving gel image quality. Also IPGs without DMA have a tendency of retaining proteins in the IPG strip (evident from FIG. 1), however this is not seen in DMA containing IPG strips and therefore there is a wider variety of proteins on the 2D image and more of the original protein extract.

### EXAMPLE 14

Results from AAP and DMA IPG Strips

With reference to FIG. 1 and FIG. 2, the separation of E.coli in conventional extraction solutions and sulfolane extraction solutions on these IPG strips gives a good separation. There appears to be protein remaining in all of the IPG strips, however this may be solubilised by multiple washing during the equilibration step. If the conventional and sulfolane extraction solution gels are over-layed, it becomes apparent that different proteins are being extracted at different rates from these solutions. This indicates that both extraction methods may be required to pull out a larger collection of proteins.

With reference to FIG. 3, The duplicates of native human plasma have achieved similar separation properties to those seen using Pharmacia 3-10 IPG strips. When comparing this gel image to one published in Electrophoresis (T. Manabe et al 1999, 20, 830-835) less streaking is present. However the published gel is a large gel (18 cm IPG strip and 20 cm in the second dimension) of native plasma and they are seeing more protein spots by using a much higher load.

The new formulation of IPG strips containing MP and DMA has been successful at rehydrating different types of extraction solutions. These sample solutions include conventional and sulfolane extraction solutions and water based extraction solutions for native gels. They have also successfully focused these proteins and produced well resolved two-dimensional gels. This IPG strip formulation has great potential to form a multi-use IPG strip.

With reference to FIG. 7, wherein conventional extraction solution used a Pharmacia 4-7 IPG strip, and the sulfolane extraction solution was rehydrated onto a laboratory made Acrylamide/DMA 4-7 IPG strip, the conventional and sulfolane extraction solutions extract similar proteins at a similar concentration to each other. By contrast, the variation of the sulfolane extraction solution extracts a lower number of proteins at a much lower concentration

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An immobilised pH gradient (IPG) gel for use in electrophoresis, the gel comprising polymerised monomeric units of (I) CH₂═CR₁—CO—NR₂R₃ and (II) CH₂═CR₄—CO—NR₅ R₆, wherein R₁, R₂, R₃, R₄, R₅, and R₆, are the same or different and are hydrogen or C₁-C₄ alkyl, with the proviso that at least one of R₁, R₂, R₃, R₄, R₅, or R₆ is C₁-C₄ alkyl.

2. The immobilised pH gradient (IPG) gel according to claim 1, wherein R₂ and R₃ are C₁-C₄ alkyl.

3. The immobilised pH gradient (IPG) gel according to claim 1, wherein R₂ and R₃ are CH₃.

4. The immobilised pH gradient (IPG) gel according to claim 1, wherein R₁ is H, and R₂ and R₃ are CH₃.

5. The immobilised pH gradient (IPG) gel according to claim 1, wherein R₅ and R₆ are the same or different and are hydrogen or propanol.

6. The immobilised pH gradient (IPG) gel according to claim 1, wherein R₄, R₅ and R₆ are H.

7. The immobilised pH gradient (IPG) gel according to claim 1, wherein R₄ and R₅ are H, and R₆ is propanol.

8. The immobilised pH gradient (IPG) gel according to claim 1, wherein the molar ratio of unit (I): unit (II) is about 1:10 to about 10:1.

9. The immobilised pH gradient (IPG) gel according to claim 1, wherein the molar ratio of unit (I): unit (II) is about 1:5 to about 5:1.

10. The immobilised pH gradient (IPG) gel according to claim 1, wherein the molar ratio of unit (I): to unit (II) is about 1:2 to about 2:1.

11. The immobilised pH gradient (IPG) gel according to claim 1, wherein the molar ratio of unit (I): to unit (II) is about 1:1.

12. The immobilised pH gradient (IPG) gel according to claim 1, wherein the gel comprises a mixture of acrylamide and Dimethylacrylamide (DMA) or a mixture of N-Acryloyl amino propanol (AAP) and Dimethylacrylamide (DMA).

13. The immobilised pH gradient (IPG) gel according to claim 12, comprising a molar ratio of acrylamide: DMA or MP: DMA of about 1:1.

14. The immobilised pH gradient (IPG) gel according to claim 1, wherein the IPG gel is attached to a solid support or backing sheet.

15. A method for separating or analysing at least one macromolecule in a sample comprising performing isoelectric focusing on a sample using the IPG gel of claim 1.

16. The method according to claim 15, the method further comprising solubilising at least one macromolecule in the sample.

17. The method according to claim 15 wherein the sample is selected from the group consisting of:
an extra-cellular fluid, tissue sample, cell sample, microorganism sample and a culture sample.

18. The method according to claim 15, wherein the macromolecule is a protein.

19. The method according to claim 16, wherein the solubilisation is performed by a process comprising mixing the sample with a hydrophobic solvent.

20. The method according to claim 19, wherein the hydrophobic solvent comprises an active ingredient selected from the group consisting of: sulfolane, sulfolene, urea, thiourea, butylurea, dimethylurea, tributyl phosphate, dimethyl sulfoxide, dimethyl formamide, a surfactant and a reducing agent.

21. The method according to claim 19, wherein the hydrophobic solvent comprises sulfolane or sulfolene or a mixture thereof.

22. The method according to claim 15, further comprising electrophoresing the sample on an SDS-polyacrylamide gel.

23. Use of the IPG gel according to claim 1 in the separation or analysis of at least one macromolecule in a sample.

24. A kit for separating and/or analysing at least one macromolecule in a sample, the kit comprising: a solubilising agent, an immobilised pH gradient (IPG) gel according to any one of claims 1-14 and optionally instructions for use.

25. The kit according to claim 24, wherein the solubilising agent is a hydrophobic solvent.

26. A kit according, to claim 24, wherein the hydrophobic solvent comprises an active ingredient selected from the group consisting of: sulfolane, sulfolene, urea, thiourea, butylurea, dimethylurea, tributyl phosphate, dimethyl sulfoxide, dimethyl formamide, a surfactant and a reducing agent.

27. The kit according to claim 26, wherein the hydrophobic solvent comprises sulfolane or sulfolene or a mixture thereof.

28. An immobilised pH gradient (IPG) gel for use in electrophoresis, the gel comprising polymerised monomeric units of acrylamide and Dimethylacrylamide (DMA) or polymerised monomeric units of N-Acryloyl amino propanol (AAP) and Dimethylacrylamide (DMA), wherein said polymerised monomeric units are at a molar ratio of 1:1.
